(19) United States
(12) Patent Application Publication
(10) Pub. No.: US 2015/0149926 A1
(43) Pub. Date: May 28, 2015

(54) EMAIL WITH PERSONAL MESSAGE

(71) Applicants: Dawn LEONARD, Tortola (VG); Linton LEONARD, Tortola (VG)

(72) Inventors: Dawn LEONARD, Tortola (VG); Linton LEONARD, Tortola (VG)

(21) Appl. No.: 14/092,161

(22) Filed: Nov. 27, 2013

(51) Int. Cl. H04L 12/58; G06F 3/0484

(52) U.S. Cl. CPC H04L 51/14; G06F 3/0484
USPC 715/752

(57) ABSTRACT

A computer-implemented method comprises providing a user interface to allow the composition of an email message. The method receives an indication of a plurality of recipients of the email message, including a first recipient. The method provides a user interface to allow the composition of a personal message for accompanying the email message, wherein the personal message is only for distribution to the first recipient. The method associates the personal message with the email message. The method forwards the email message and the personal message to a mail server. Another network device receives the email message and personal message. It forwards the email message to the plurality of recipients and forwards the personal message only to the first recipient.

### BACKGROUND

Electronic mail (abbreviated to email hereafter) is a widely used form of communication. A user typically uses some form of Mail User Agent (MUA) to access their email mailbox. The MUA provides a user interface which allows a user to compose an email and select recipients of the mail. An email can be sent to one recipient, or to multiple recipients. In the case of multiple recipients, all recipients will receive the same message content.

The embodiments described below are not limited to implementations which solve any or all of the disadvantages of known email systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computer-implemented method comprises providing a user interface to allow the composition of an email message. The method receives an indication of a plurality of recipients of the email message, including a first recipient. The method provides a user interface to allow the composition of a personal message for accompanying the email message, wherein the personal message is only for distribution to the first recipient. The method associates the personal message with the email message. The method forwards the email message and the personal message to a mail server. Another network device receives the email message and personal message. It forwards the email message to the plurality of recipients and forwards the personal message only to the first recipient.

A computer-implemented method comprises providing a user interface to allow the composition of an email message. The method comprises receiving an indication of a plurality of recipients of the email message, including a first recipient. The method comprises providing a user interface to allow the composition of a personal message for accompanying the email message. The personal message is only for distribution to the first recipient. The method comprises associating the personal message with the email message. The method comprises forwarding the email message and the personal message to a mail server.

A computer-implemented method comprises receiving an email message intended for distribution to a plurality of recipients. The email message has a personal message associated with it. The personal message is only intended for distribution to the first recipient. The method comprises forwarding the email message to the plurality of recipients. The method comprises forwarding the personal message only to the first recipient.

A computer-implemented method of processing an email message for a first recipient comprises receiving an email message having a plurality of recipients, including the first recipient. The method comprises determining if the email message has a personal message associated with it, wherein the personal message is only for the first recipient. If it is determined that the email message has a personal message associated with it, the method causes a user interface to present the personal message to the first recipient.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows an example of an email system;

FIG. 2 shows another example of an email system;

FIG. 3 shows steps of composing and distributing an email;

FIG. 4 shows a user interface at a user device for composing an email;

FIGS. 5A and 5B show a user interface at a user device for composing a personal message to accompany an email;

FIGS. 6A to 6C show a user interface at a user device for displaying an email and a personal message to a recipient;

FIG. 7 shows forwarding of a personal message between users;

FIG. 8 shows a computer-implemented method which can be performed by a computing-based device at a user device or a network device associated with a sender of an email message;

FIG. 9 shows a computer-implemented method which can be performed by a computing-based device, such as a mail server associated with a sender of an email message;

FIG. 10 shows a computer-implemented method which can be performed by a computing-based device at a user device or a network device associated with a first recipient of an email message;

FIG. 11 shows a computing-based device which can be used to implement any described method.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

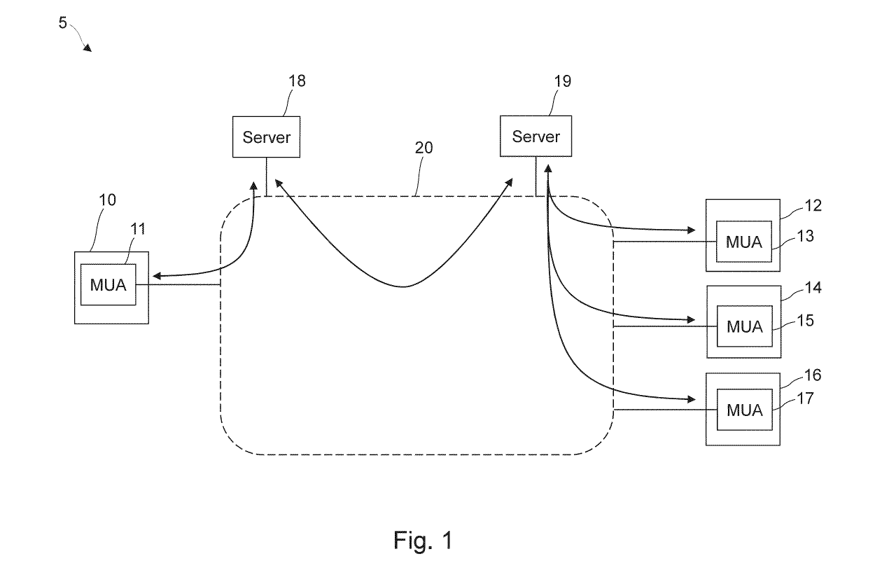

FIG. 1 schematically shows an overall email distribution system 5 for a plurality of users. A user can access their mailbox via any suitable device 10, 12, 14, 16, such as a personal computer, laptop computer, tablet, mobile telephone (smart phone). The user device can have client software to provide a Mail User Agent (MUA) 11, 13, 15, 17. A MUA is software executed by the device 10 which allows the device to access the mail service. Examples of mail client software are Microsoft Outlook™, Mozilla Thunderbird™ and Apple Mail™. This arrangement is shown in FIG. 1. The MUA 11, 13, 15, 17 provides a user interface which allows a user to perform mail-related functions, such as viewing the contents of the user's mailbox and composing a new email.

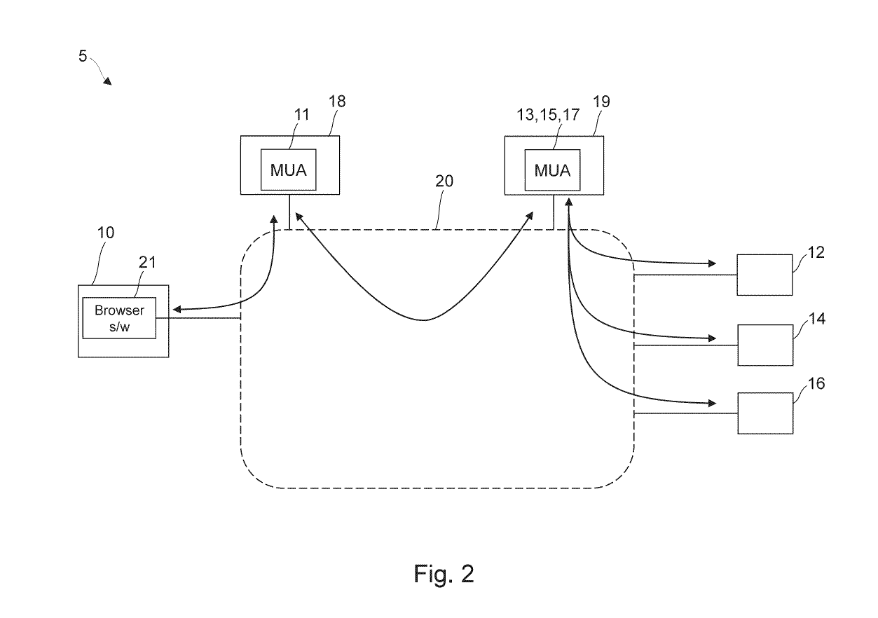

Alternatively, the user device 10 may use a web-based MUA, typically known as webmail. This arrangement is shown in FIG. 2. In this case, the MUA 11 is hosted by a network server 18 and the user's device uses conventional web browser software 21 to communicate with the MUA 11. Examples of webmail are Yahoo! Mail™, Gmail™, Hotmail™. The web browser 21 displays a web page for the webmail service which can provide the same, or a similar, user interface as the one provided by the client-based MUA software of FIG. 1.

It will be understood that a device can be dedicated to a particular user (e.g. a user's personal smart phone), or one device can be used by multiple users (e.g. a public computer separately used by multiple users to access their webmail accounts, or a shared computer to which different users log on to at different times).

In each of FIG. 1 and FIG. 2, the user's mailbox can be hosted by a mail server 18. A plurality of mail servers 18, 19 are shown in FIG. 1. Depending on which mail service a user subscribes to, the mail server for a set of users can be the same, or different. A network 20 provides connectivity to the user devices 10, 12, 14, 16 and to the mail servers 18, 19 to support communication between them. The network 20 can be a wide area network, such as the Internet, a local area network (LAN), or a combination of network types. For clarity, an email service provider is represented in FIG. 1 by a single server 18. It will be understood that a mail system of an email service provider can comprise a set of servers which are linked. The mail server 18 can comprise a Mail Delivery Agent/Message Delivery Agent (MDA). Protocols for communication between the client-based MUA and mail server, and between a web browser software and web-based MUA/webmail are known to a skilled person.

A user device 10, 12, 14, 16 has a user interface which allows a user to compose a new email and to select recipients of the email. Multiple recipients can be selected for the same mail. A recipient can be selected in various ways. Typically, a recipient can be selected by one or more of: entering a recipient's email address into a data entry field on the user interface; entering a recipient's name into a data entry field on the user interface, which automatically retrieves a stored email address for that name; and selecting a recipient's name in an address book.

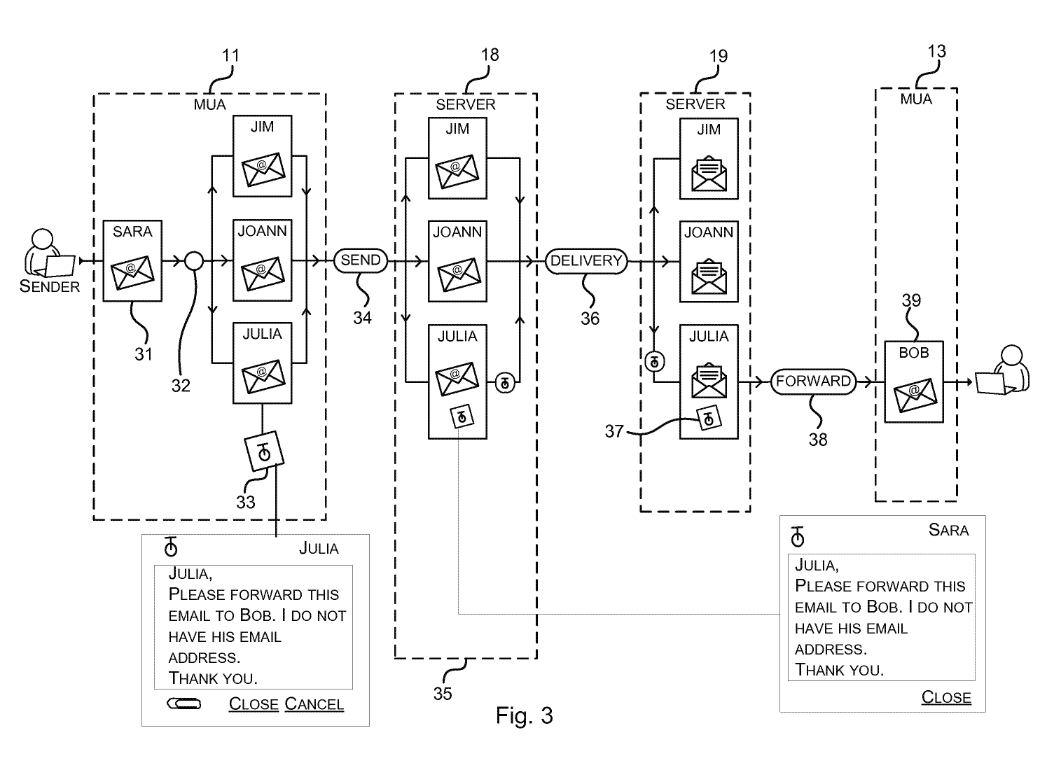

In addition, the user interface allows the user to send a personal message to one or more of the recipients of the email message, without having to send a second email message. The process is shown in FIG. 3. At step 31 the user composes an email using their MUA 11. At step 32 the user selects recipients for the email. Steps 31 and 32 can be performed in any order, or the step 32 can be performed during the step 31 of composing the email. At step 33 the user selects one of the recipients to receive a personal message. In various examples, this can be performed after the user has selected recipients for the overall email message (at step 32) by selecting an icon on the user interface. This icon will be called the “Tag-on” icon. When a user selects the “Tag-on” icon, this can cause a drop bar of all the recipients of the email to be displayed. When a user selects one of the recipients, this can then cause a composition window to be displayed. The user can type their personal message to the recipient. Additionally, or alternatively, the user can add a private attachment for the recipient. On completion of the personal message, the user can return to the main user interface. A Tag-on can be cancelled at any time while in the composition window by clicking “Cancel”. At step 34, on completion of the email and personal message composition, the user sends the email.

The personal message can be associated with the email in a similar manner to an attachment of the email.

The personal message can be associated with a particular email address of a recipient of the email. A mail server can inspect the relationship (defined in the email) between the personal message and a recipient email address, and forward the personal message according to that relationship.

The email is received by a mail server 18 (e.g. a Mail Delivery Agent, MDA), for routing to recipients. The mail server 18 processes the email. The mail server 18 forwards the email to all recipients listed in the email. Additionally, the mail server 18 forwards the personal message only to the recipient which is identified as being the recipient of the personal message. The personal message is forwarded as part of the email to that recipient. No other recipients receive the personal message. There can be multiple personal messages associated with the email. Each personal message has a 1:1 relationship with a recipient. For example, a personal message to recipient 1 (device 12, MUA 13) is only forwarded to recipient 1, a personal message to recipient 2 (device 14, MUA 15) is only forwarded to recipient 2, and so on. At step 37 all recipients receive the same email. Only the recipient originally identified at step 33 receives the personal message. The personal message can remain stored with the email.

The MUA of a recipient can determine if the email message has a personal message associated with it. If it is determined that the email message has a personal message associated with it, the MUA can cause a user interface to provide an indication that there is a personal message associated with the email message. An example user interface is described below. The personal message can be presented in response to receiving an input indicating that the first recipient wishes to view the personal message. Alternatively, the personal message can be automatically presented alongside the email message, without any need for a user to request presentation of the personal message.

Subsequently, the recipient may wish to forward the email received at step 37 to one or more recipients. The email can be forwarded, but the personal message cannot be forwarded, i.e. it remains personal to the original recipient. This is shown at step 39, by the email without the personal message. The recipient at step 37 can compose their own personal message, but cannot forward the personal message they received.

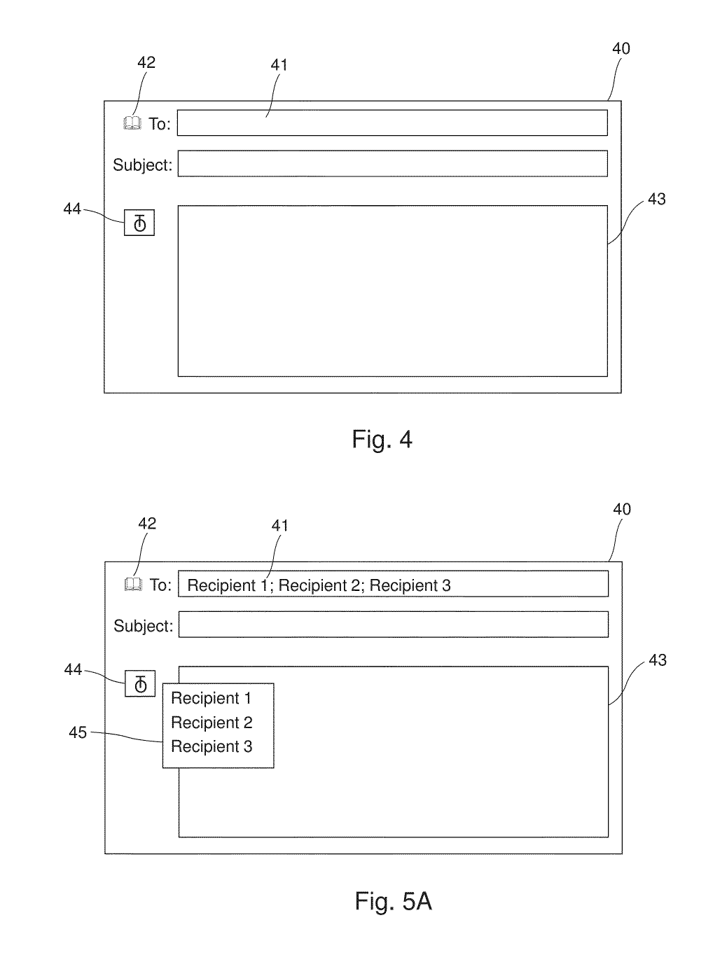

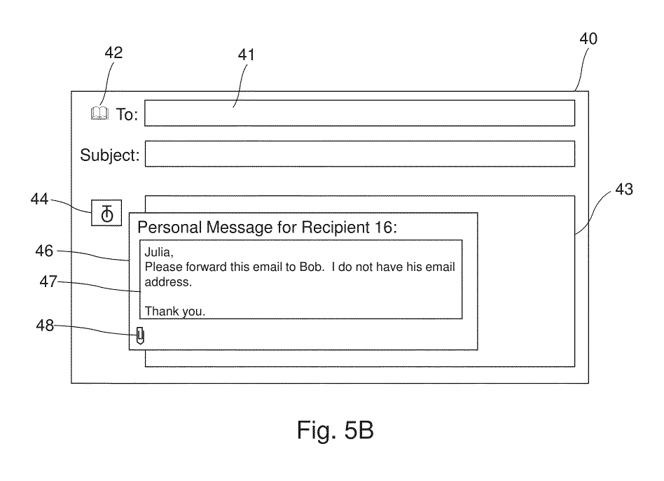

FIG. 4 shows an example format of a window 40 provided as part of the user interface at a user device. The window 40 is for composing an email and can be displayed as a result of a result selecting to compose a new email. As in a conventional user interface, the window 40 comprises a data entry field 41 for entering a name or email address of a recipient. Multiple names/addresses can be entered in field 41. An address book icon 42 may also be provided. A data entry field 43 is provided for allowing a user to enter the text of the email message. A “Tag-on” icon 44 is displayed in the window 40. The position of the “Tag-on” icon 44 can be different to the position shown in FIG. 4. By selecting the “Tag-on” icon 44, a user begins the sequence of steps for composing a personal message, shown in FIGS. 5A and 5B.

Referring to FIG. 5A, it is assumed that a user has already begun to compose an email message to three recipients: Recipient 12, Recipient 14 and Recipient 16. A user has selected the “Tag-on” icon (e.g. by clicking on it, or by touching the icon 44 on a touch-sensitive display screen). This causes a drop bar 45 of all the recipients of the email to be displayed. For this example, it is assumed that the user selects Recipient 16 as the person to receive a personal message. As shown in FIG. 5B, a new window 46 is displayed to allow composition of the personal message. The window 46 has a data entry box 47 for allowing the user to compose the personal message. The user can enter text using a data interface of the device 10, such as a keyboard or touch screen. An attachment icon 48 is displayed in window 46. By selecting icon 48, a further window is displayed which allows the user to select a file for attaching to the personal message. For example, storage sources on the device (e.g. hard disk, memory stick, desktop) and any network-accessible locations (if available) can be displayed.

The user interface can allow selection of an appearance of the personal message. The appearance can comprise a background design for the personal message (e.g. a solid color, graphical pattern, image). Additionally, or alternatively, the appearance can comprise a scheme for the text of the message such as text color, text font, text size etc. The user interface can allow selection of an appearance of the personal message from a plurality of stored definitions of appearances. The plurality of appearance definitions can comprise one or more of: predetermined template designs; a design previously created by the user. The appearances can be presented as a gallery, e.g. illustrating how sample text will appear if that definition is selected. The method can associate the selected appearance with the personal message. Code defining the appearance can accompany the personal message. Alternatively, the appearance can be identified by an identification code which accompanies the personal message, and which can be used by a mail server to retrieve the definition of the appearance from a network server, or from a store of definitions stored locally at the recipient's mail server or MUA/device.

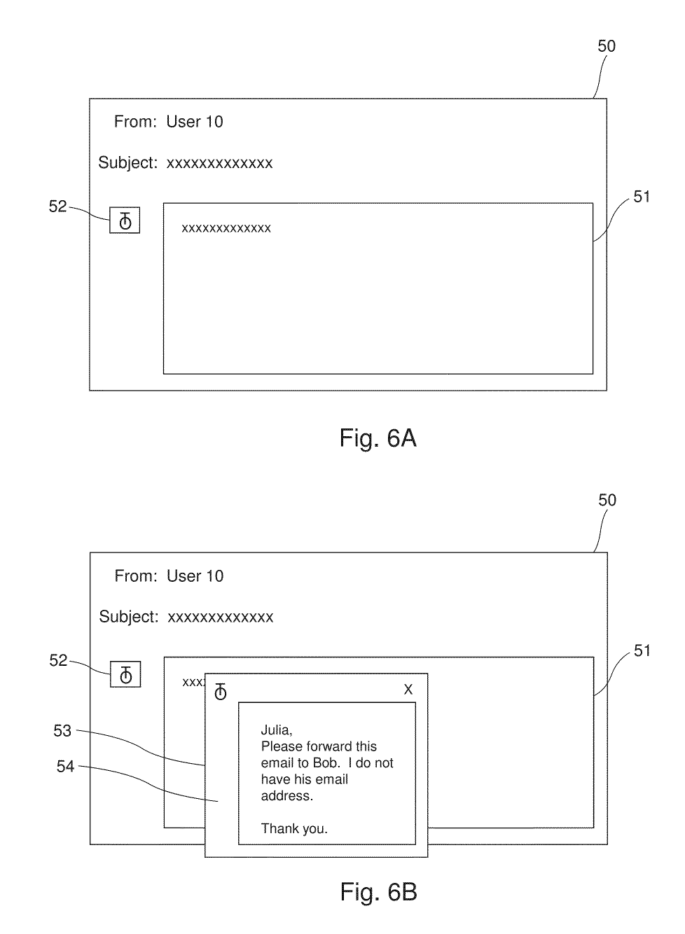

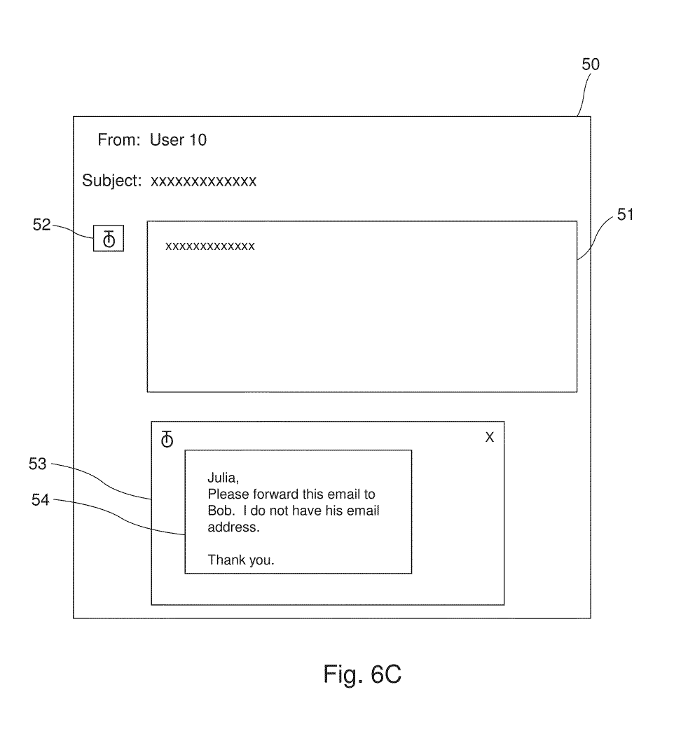

FIGS. 6A and 6B show an example format of a window 50 provided as part of the user interface at a user device when displaying a received mail to a recipient. A box 51 is provided for displaying text (and/or images) of a message. A “Tag-on” icon 52 is displayed within window 50 when there is a personal message accompanying the email. Selecting, or moving a cursor over, the icon 52 can reveal the personal message, as shown in FIG. 6B. Another possibility is that the personal message can be displayed automatically when the email is selected for display by the user, e.g. in a pop-up window of the type shown in FIG. 6B or in a further window alongside the main email content. In the case of a pop-up window, the window 53 displaying the personal message may appear overlaid across at least part of the main email window, in a similar manner to a sticky note.

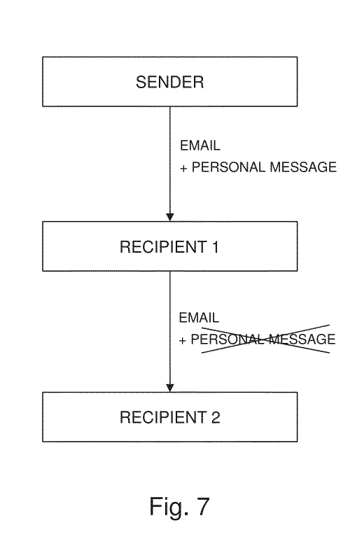

FIG. 7 illustrates the forwarding rules for the email message and personal message between a set of users. Each user is represented in FIG. 4 by their respective device 10, 12, 14. A first user 10 can send an email message to multiple recipients. A recipient 12 receives the email and a personal message from user 10 which is intended only for that recipient 1. Recipient 1 can forward the email to recipient 2, but cannot forward the personal message it received from user 10 to recipient 1. The MUA associated with recipient 1 and/or the mail server associated with recipient 1 can be arranged to inspect the email message when forwarding of the email is requested. If a personal message is found, it is not forwarded. One way of achieving this is to set a flag associated with the email when it is forwarded for the first time. Thereafter, when a MUA and/or mail server inspects this flag, if the flag is found to have a value indicating that the message has already been forwarded, further forwarding of the personal message is prohibited. Another possibility is that the personal message can be removed from the email message when the user attempts to forward the email message (e.g. by the MUA and/or mail server). The Tag-On interface can be programmed with a message forwarding restriction. After a Tag-On is received and read it can be automatically removed and saved in a Tag-On folder. The folder can have the same name as the subject line of the email. This can prohibit it from ever being forwarded.

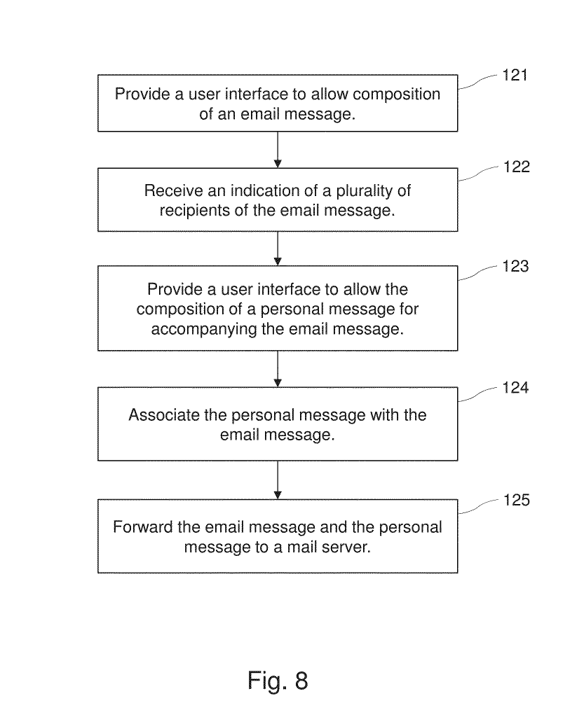

FIG. 8 shows a computer-implemented method which can be performed by a computing-based device at a user device or a network device associated with a sender of an email message. The method comprises a step 121 of providing a user interface to allow the composition of an email message. The method comprises a step 122 of receiving an indication of a plurality of recipients of the email message, including a first recipient. The method comprises a step 123 of providing a user interface to allow the composition of a personal message for accompanying the email message, wherein the personal message is only for distribution to the first recipient. The method comprises a step 124 of associating the personal message with the email message. The method comprises a step 125 of forwarding the email message and the personal message to a mail server.

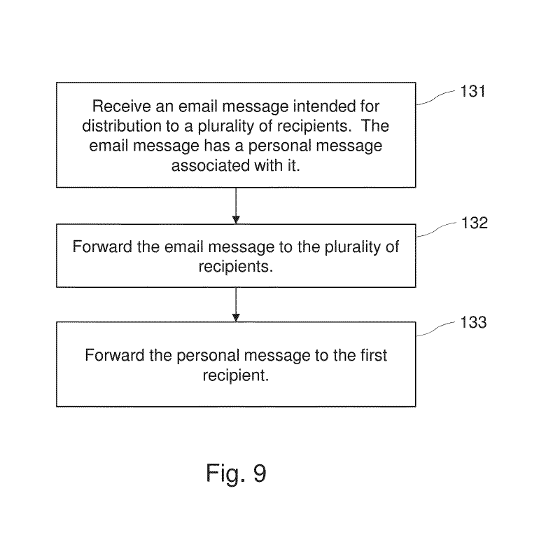

FIG. 9 shows a computer-implemented method which can be performed by a computing-based device, such as a mail server associated with a sender of an email message. The method comprises a step 131 of receiving an email message intended for distribution to a plurality of recipients. The email message has a personal message associated with it. The personal message is only intended for distribution to the first recipient. The method comprises a step 132 of forwarding the email message to the plurality of recipients. The method comprises a step 133 of forwarding the personal message to the first recipient.

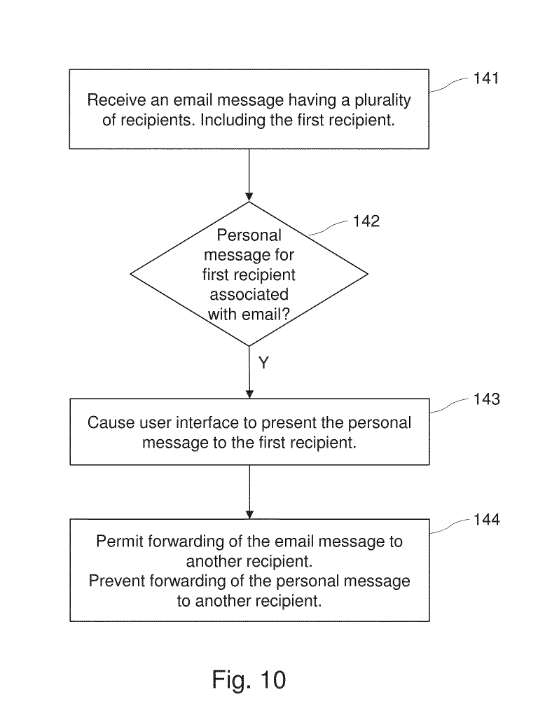

FIG. 10 shows a computer-implemented method which can be performed by a computing-based device at a user device or a network device associated with a first recipient of an email message. The method comprises a step 141 of receiving an email message having a plurality of recipients, including the first recipient. The method comprises a step 142 of determining if the email message has a personal message associated with it. The personal message is only for the first recipient. If it is determined that the email message has a personal message associated with it for the first recipient, the method proceeds to step 143 and causes a user interface to present the personal message to the first recipient. The method can comprise a step 144 of permitting forwarding of the email message to another recipient and preventing forwarding of the personal message to another recipient.

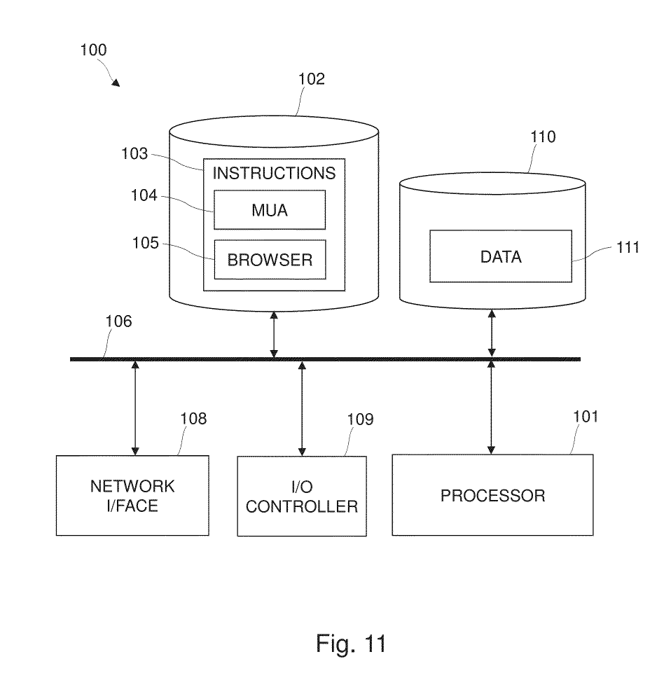

FIG. 11 illustrates various components of an exemplary computing-based device 100 which may be implemented as any form of a computing and/or electronic device, and in which embodiments may be implemented.

Computing-based device 100 comprises one or more processors 101 which may be microprocessors, controllers or any other suitable type of processors for processing computer executable instructions to control the operation of the device. In some examples, for example where a system on a chip architecture is used, the processors 101 may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

The computer executable instructions 103 may be provided using any computer-readable media that is accessible by computing based device 100. The instructions can comprise instructions 104 for implementing a MUA and instructions for implementing a web browser. Computer-readable media may include, for example, non-transitory computer storage media such as memory 102 and communications media. Computer storage media, such as memory 102, includes volatile and non-volatile, removable and non-removable media implemented in any method or technology for storage of information such as computer readable instructions, data structures, program modules or other data. Computer storage media can also include memory 110 for storing any data 111. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Although the computer storage media (memory 102) is shown within the computing-based device 100 it will be appreciated that the storage may be distributed or located remotely and accessed via a network or other communication link (e.g. using communication interface 108).

The computing-based device 100 also comprises an input/output controller 109 arranged to output display information to a display device which may be separate from or integral to the computing-based device 100. The display information may provide a graphical user interface. The input/output controller 109 is also arranged to receive and process input from one or more devices, such as a user input device (e.g. a mouse or a keyboard). In an embodiment the display device may also act as the user input device if it is a touch sensitive display device.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

An aspect provides one or more tangible device-readable media with device-executable instructions that, when executed by a computing system, direct the computing system to perform steps comprising: providing a user interface to allow the composition of an email message; receiving an indication of a plurality of recipients of the email message, including a first recipient; providing a user interface to allow the composition of a personal message for accompanying the email message, wherein the personal message is only for distribution to the first recipient; associating the personal message with the email message; and forwarding the email message and the personal message to a mail server.

An aspect provides one or more tangible device-readable media with device-executable instructions that, when executed by a computing system, direct the computing system to perform steps comprising: receiving an email message intended for distribution to a plurality of recipients, wherein the email message has a personal message associated with it and wherein the personal message is only intended for distribution to the first recipient; forwarding the email message to the plurality of recipients; and forwarding the personal message to the first recipient.

An aspect provides one or more tangible device-readable media with device-executable instructions that, when executed by a computing system, direct the computing system to perform steps comprising: receiving an email message having a plurality of recipients, including a first recipient; determining if the email message has a personal message associated with it, wherein the personal message is only for the first recipient; and if it is determined that the email message has a personal message associated with it, causing a user interface to present the personal message to the first recipient.

Other aspects provide an apparatus comprising a processor and a memory, the memory containing instructions executable by the processor whereby the apparatus is operative to perform any of the aspects defined above.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A computer-implemented method comprising:
providing a user interface on a computing-based device to allow the composition of an email message;
receiving an indication of a plurality of recipients of the email message, including a first recipient;
providing a user interface on the computing-based device to allow the composition of a personal message for accompanying the email message, wherein the personal message is only for distribution to the first recipient;
associating the personal message with the email message;
forwarding the email message and the personal message to a mail server.

2. The method according to claim 1 wherein the step of providing the user interface to allow the composition of the personal message further comprises:
displaying the plurality of recipients of the email message;
receiving a selection of the first recipient; and
displaying a data entry box on the user interface to allow the composition of the personal message for the first recipient.

3. The method according to claim 1 wherein the user interface allows the association of an attachment with the personal message, wherein the attachment is only intended for distribution to the first recipient.

4. The method according to claim 1 wherein the user interface allows selection of an appearance for the personal message and the method further comprises:
receiving a selection of the appearance; and
associating the selection of the appearance with the personal message.

5. The method according to claim 4 wherein the user interface allows selection of an appearance for the personal message from a plurality of stored appearance definitions.

6. The method according to claim 1 wherein the step of associating the personal message with the email message comprises associating the personal message as an attachment to the email message.

7. The method according to claim 1 wherein the step of associating the personal message with the email message comprises associating the personal message with an email address of the first recipient.

8. A computer-implemented method comprising:
receiving an email message intended for distribution to a plurality of recipients at a mail server, wherein the email message has a personal message associated with it, the personal message only intended for distribution to the first recipient;
forwarding, from the mail server, the email message to the plurality of recipients;
forwarding, from the mail server, the personal message to the first recipient.

9. The method according to claim 8 wherein the email message carries data defining a relationship between the personal message and an email address of the first recipient, and the method further comprises inspecting the data and using the data to forward the personal message.

10. A computer-implemented method of processing an email message for a first recipient comprising:
receiving at a computing-based device an email message having a plurality of recipients, including the first recipient;
determining if the email message has a personal message associated with it, wherein the personal message is only for the first recipient;
if it is determined that the email message has a personal message associated with it, causing a user interface to present the personal message to the first recipient.

11. The method according to claim 10 further comprising:
permitting forwarding of the email message to another recipient; and
preventing forwarding of the personal message to another recipient.

12. The method according to claim 10 wherein, if it is determined that the email message has a personal message associated with it, causing a user interface to provide an indication that there is a personal message associated with the email message.

13. The method of claim 10 wherein the step of presenting the personal message comprises displaying a personal message window.

14. The method of claim 13 wherein the personal message window is displayed in an overlaid relationship to a window displaying content of the email message.

15. The method of claim 13 wherein an appearance of the personal message window is determined by code associated with the personal message.

16. The method of claim 13 wherein an appearance of the personal message window is determined by an identification code associated with the personal message, and the method further comprises using the identification code to retrieve a definition of the appearance.
